(19) United States
(12) Patent Application Publication
(10) Pub. No.: US 2015/0154488 A1
(43) Pub. Date: Jun. 4, 2015

(54) RADIO FREQUENCY IDENTIFICATION TAG AND METHOD OF MANUFACTURING THE SAME

(71) Applicant: EXAN INC., Gumi-si, Gyeongsangbuk-do (KR)

(72) Inventors: Soon Yeong Heo, Cheonan-si (KR); Seong Sil Park, Cheonan-si (KR); Seung Jun Han, Cheonansi (KR); Hyun Mi Lee, Cheonan-si (KR)

(21) Appl. No.: 14/411,948

(22) PCT Filed: May 24, 2013
(86) PCT No.: PCT/KR2013/004553

§ 371 Date: Dec. 30, 2014

(30) Foreign Application Priority Data
Jun. 7, 2012 (KR) 10-2012-0074070
Apr. 9, 2013 (KR) 10-2013-0038875

(51) Int. Cl. G06K 19/077

(52) U.S. Cl. CPC G06K 19/07728; G06K 19/07722; G06K 19/07783; G06K 19/07794; G06K 19/07786

(57) ABSTRACT

An RFID tag includes a textile including a loop region and a dipole region defined adjacent to the loop region, a dipole portion disposed in the dipole region and on the textile to be configured to receive an electric wave from outside, a loop portion disposed in the loop region and over the dipole portion to be configured to be capacitive coupled to the dipole portion to form an antenna together, an RFID chip interposed between the dipole portion and the loop portion, the RFID including a driving circuit for receiving and transmitting an electric wave through the antenna and a protective layer disposed on the textile with covering the dipole portion to protect the dipole portion.

### CROSS REFERENCE TO RELATED APPLICATION

This application claims priority under R.O.C Patent law to both Korean Patent Application Nos. 2012-0074070, filed on Jul. 6, 2012 and 2013-0038875, filed on Apr. 9, 2013 the contents of which are herein incorporated by reference in its entirety for all purposes.

### BACKGROUND

1. Field

The example embodiments of the present inventions relate generally to a radio frequency identification (hereinafter, referred to as “RFID”) tag and a method of manufacturing the RFID tag. More particularly, the example embodiments of the present inventions relate to an RFID tag for communicating information on production and logistics using a RFID chip and electric wave and a method of manufacturing the RFID tag.

2. Description of the Related Art

Generally, an RFID tag includes an antenna formed on an insulating sheet and a RFID chip connected to the antenna.

The antenna may be formed on the insulating sheet by a photolithographic process using a noble metal having a relatively good conductivity, such as a process for forming a printed circuit board (PCB). Then, the chip may be mounted on the antenna. The photolithographic process for forming the antenna may include a step for forming a photoresist pattern on a metal layer being made of the noble metal and a step of partially etching the metal layer using an etchant solution. Thus, the photolithographic process may have relatively complicate steps. Further, since the noble metal may be used, the economic efficiency of the photolithographic process may be worse and the etchant solution may cause lots of environmental issues.

For example, in order to adopt the RFID tag on a production line or a logistic line of apparels related to the textiles, there may have been many problems in forming the antenna on the textile and bonding an RFID chip to the textile. Further, when the textile has washed many times, the RFID tag may have worse reliability.

### SUMMARY

Example embodiments of the present invention provide an RFID tag includes a textile including a loop region and a dipole region defined adjacent to the loop region, a dipole portion disposed in the dipole region and on the textile to be configured to receive an electric wave from outside, a loop portion disposed in the loop region and over the dipole portion to be configured to be capacitive coupled to the dipole portion to form an antenna together, an RFID chip interposed between the dipole portion and the loop portion, the RFID including a driving circuit for receiving and transmitting an electric wave through the antenna and a protective layer disposed on the textile with covering the dipole portion to protect the dipole portion. Here, the protective layer may include a UV-cured material.

In accordance with some example embodiments of the present invention, the RFID tag may further include a passivation layer covering the loop portion to be configured to passivate the loop portion and the RFID chip.

In accordance with some example embodiments of the present invention, the RFID tag may further include an adhesion portion to adhere the RFID chip to the textile.

In accordance with some example embodiments of the present invention, each of the dipole portion and the loop portion may include at least one of conductive metal particles selected from the group consisting of silver (Ag), copper (Cu), silver-coated copper (Ag-coated Cu) and silver-coated iron (Ag-coated Fe).

In accordance with some example embodiments of the present invention, the RFID tag may further include a planarizing layer disposed on an upper face of the textile, to have a flat upper face of the planarizing layer. Here, the planarizing layer may include polyurethane.

In accordance with example embodiments of the present invention, there is provided a method of manufacturing an RFID tag. In the method, provided is a textile including a loop region and a dipole region defined adjacent to the loop region. Formed is a dipole structure having a dipole portion in the dipole region and on the textile to be configured to receive an electric wave from outside. A loop portion is formed on a passivation layer to correspond to the loop region, the loop porting being capacitive coupled to the dipole portion. Bonded is an RFID chip having a driving circuit for communicating an electric wave with the loop portion to form a loop structure on the passivation layer. The dipole structure is combined with the loop structure with exposing the passivation layer. A protecting layer is formed on the textile, the protecting layer covering the dipole portion to protect the dipole portion.

In accordance with some example embodiments of the present invention, the protective layer may be formed by forming a UV-cured layer covering the dipole region on the textile and exposing the UV-cured layer to UV rays to cure the UV-cured layer.

In accordance with some example embodiments of the present invention, combining the dipole structure with the loop structure may be performed using an adhesion portion.

In accordance with some example embodiments of the present invention, the method may further include forming a planarizing layer having a plane upper face on the textile.

In accordance with some example embodiments of the present invention, the planarizing layer may be formed by a laminating process using polyurethane material.

In accordance with some example embodiments of the present invention, the planarizing layer may be formed by a coating process using polyurethane material.

### BRIEF DESCRIPTION OF THE DRAWINGS

Example embodiments of the present invention will become readily apparent along with the following detailed description when considered in conjunction with the accompanying drawings, in which:

FIG. 1 is a plan view illustrating an RFID tag in accordance with an example embodiment of the present invention;

FIG. 2 is a cross-sectional view an RFID tag in accordance with an example embodiment of the present invention;

FIG. 3 is a plan view illustrating a textile shown in FIG. 1;

FIG. 4 is a cross-sectional view illustrating a planarizing layer and a dipole portion in accordance with an example of the present invention; and

FIG. 5 is a flow chart illustrating a method of manufacturing an RFID tag in accordance with an example embodiment of the present invention.

### DESCRIPTION OF THE EMBODIMENTS

The present invention is described more fully hereinafter with reference to the accompanying drawings, in which example embodiments of the present invention are shown. The present invention may, however, be embodied in many different forms and should not be construed as limited to the example embodiments set forth herein. Rather, these embodiments are provided so that this disclosure will be thorough and complete, and will fully convey the scope of the present invention to those skilled in the art. In the drawings, the sizes and relative sizes of layers and regions may be exaggerated for clarity.

It will be understood that when an element or layer is referred to as being “on” or “connected to” another element or layer, it can be directly on or connected to the other element or layer or intervening elements or layers may be present. In contrast, when an element is referred to as being “directly on” or “directly connected to” another element or layer, there are no intervening elements or layers present. Like reference numerals refer to like elements throughout. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “lower,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Example embodiments of the present invention are described herein with reference to cross-sectional illustrations that are schematic illustrations of idealized embodiments (and intermediate structures) of the present invention. As such, variations from the shapes of the illustrations as a result, for example, of manufacturing techniques and/or tolerances, are to be expected. Thus, example embodiments of the present invention should not be construed as limited to the particular shapes of regions illustrated herein but are to include deviations in shapes that result, for example, from manufacturing. The regions illustrated in the figures are schematic in nature and their shapes are not intended to illustrate the actual shape of a region of a device and are not intended to limit the scope of the present invention.

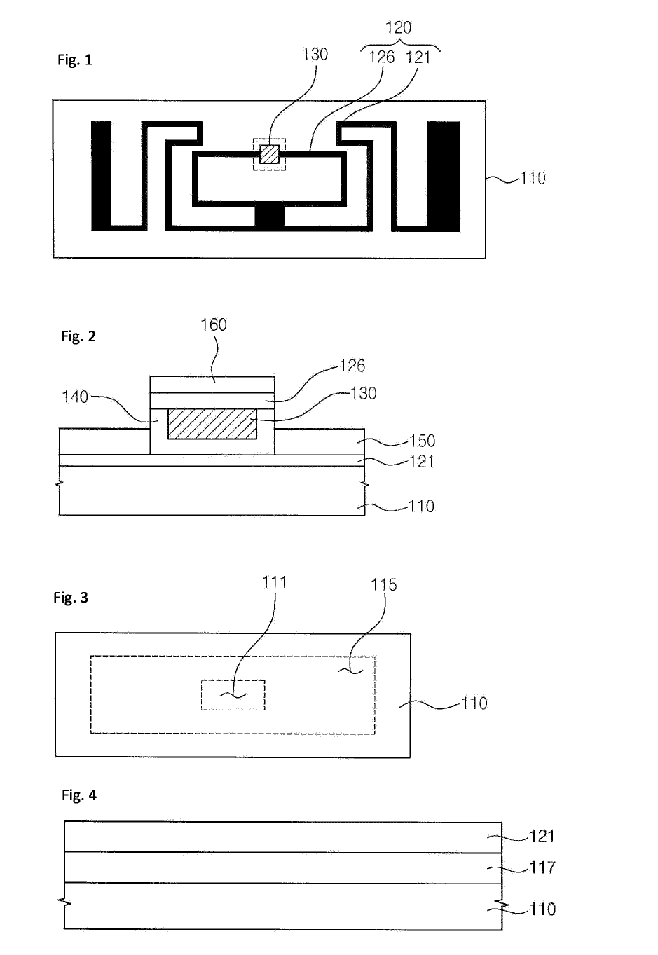

FIG. 1 is a plan view illustrating an RFID tag in accordance with an example embodiment of the present invention. FIG. 2 is a cross-sectional view an RFID tag in accordance with an example embodiment of the present invention. FIG. 3 is a plan view illustrating a textile shown in FIG. 1.

Referring to FIGS. 1 to 3, an RFID tag 100 in accordance with an example embodiment of the present invention includes a textile 110, a dipole portion 121, a loop portion 126, an RFID chip 130 and a protective layer 150.

The textile 110 may include a generally-weaved fabric. The textile 110 may be formed using a chemical fiber like nylon. The textile 110 may have an area divided into a loop region 111 and a dipole region 115 defined adjacent to the loop region 111.

The dipole portion 121 is disposed on the textile 110. The dipole region 121 is disposed in the dipole region 115. The dipole portion 121 is configured to receive an electric wave from outside.

The dipole portion 121 may have a length to be proportional to a wavelength of the electric wave which may be provided for a transponder. The shorter the wavelength of the electric wave is, the shorter the length of the dipole portion 121 is. On the other hand, the longer the wavelength of the electric wave is, the longer the length of the dipole portion 12 is.

Further, in order to decrease an area of the dipole portion 121 occupied on the textile 110, the dipole portion 121 may have a meander shape. Thus, the dipole portion 121 may have a relatively high inductance.

The dipole portion 121 may have a first conductive material. For example, the dipole portion 121 may be formed using a conductive metallic paste including at least one of silver (Ag), copper (Cu), silver-coated copper (Ag-coated Cu) and silver-coated iron (Ag-coated Fe).

The loop portion 126 is disposed in the loop region 111. The loop portion 126 is disposed over the textile 110. The loop portion 126 is capacitive coupled to the dipole portion 121 such that an antenna 120 having the dipole portion 121 and the loop portion 126 is defined.

The loop portion 126 has a bonding region in which the RFID chip 130 is boned. The loop portion 126 may have a loop shape having the bonding area for being connected to the RFID chip 130.

The loop portion 126 is configured to be connected to the dipole portion 121. An inductive reactance between the loop portion 126 and the antenna 120 including the dipole portion 121 may be controllable. In other words, as a shape and a length of the loop portion 126 may have change, the inductive reactance may be adjusted.

The loop portion 126 may have a second conductive material. The second conductive material may be identical to the first conductive material. For example, the loop portion 126 may be formed using a conductive metallic paste including one of silver (Ag), copper (Cu), silver-coated copper (Ag-coated Cu) and silver-coated iron (Ag-coated Fe). Alternatively, the second conductive material may be different from the first conductive material.

The RFID chip 130 is interposed between the loop portion 126 and the dipole portion 121. The RFID chip 130 may be bonded in the bonding region of the loop portion 126.

The RFID chip 130 may include a driving circuit for communicating an electric wave through the antenna 120. In other words, the RFID chip 130 may include a feeding circuit (not shown) for rectifying an electric wave applied through the dipole portion 121 and the loop portion 126 and for generating a driving power. The feeding circuit may include a schottky diode and a capacitor. The feeding circuit may have a capacitive reactance.

In order to efficiently transmit the electric wave from the antenna 120 including the dipole portion 121 and the loop portion 126 to the feeding circuit, the impedance matching between the antenna 120 and the feeding circuit may be required. Thus, a maximum intensity of the electric wave may be transmitted from the antenna 120 to the RFID chip 130 on the condition of the impedance matching between the antenna 120 and the feeding circuit.

The protective layer 150 is disposed on the textile 110 with covering the dipole portion 121. The protective layer 150 may protect the dipole portion 121. That is, the protective layer 150 may suppress damage of the dipole portion 121 while washing clothes including the RFID tag 100 to improve a reliability of the RFID tag 100. The protective layer 150 may be formed selectively in the dipole region. Alternatively, the protective layer 150 may be formed on an entire face of the textile 110.

The protective layer 150 may be made of a UV-curable material. In other words, the protective layer 150 may include resin having a photo-initiator. Thus, when resin is exposed to ultra-violet (UV) rays, the photo-initiator may generate a photo-polymeration reaction to form the protective layer 150.

According to an example embodiment, the RFID tag 100 may further include a passivation layer 160 covering the RFID chip 130 and the loop portion 126. The passivation layer 160 may passivate the RFID chip 130 and the loop portion 126 from external humidity or shock. The passivation layer 160 may include a polyimide film or a paper. The passivation layer 160 may be easily removed from the textile 110 together with the RFID chip 130 such that the RFID chip 130 may be removed from the textile 110 in case that user does not want to chase a position of apparel having RFID tag 100. Further, the protective layer 150 may be disposed covering the passivation layer 160 as well as the dipole portion 121.

According to an example embodiment, the RFID tag 100 may further include an adhesion portion 140. The adhesion portion 140 may fix the RFID chip 130 to the textile 110. The adhesion portion 140 may include a glue component. Thus, the adhesion portion 140 may easily attach the RFID chip 130 to the textile 110.

According to an example embodiment, the RFID tag 100 may further include an auxiliary protective layer (not shown) interposed between the dipole portion 121 and the protective layer 150. The auxiliary protective layer may be disposed on an upper face of the dipole portion 121. The auxiliary protective layer may be formed using a material substantially identical to that of the protective layer 150. The auxiliary protective layer may suppress damage of the dipole portion 120 or the RFID chip 130 caused by the adhesion portion 140, when the RFID chip 130 is detached from the textile 110 due to defects of the RFID chip 130.

FIG. 4 is a cross-sectional view illustrating a planarizing layer and a dipole portion in accordance with another example of the present invention.

Referring to FIG. 4, an RFID tag 100 in accordance with an example embodiment of the present invention may further include a planarizing layer 117.

The planarizing layer 117 is formed on an upper face of the textile 110. The planarizing layer 117 may have a flat upper face. The planarizing layer 117 may have a polymer material like polyurethane. The planarizing layer 117 may be formed by a laminating process. Alternatively the planarizign layer 117 may be formed by a coating process.

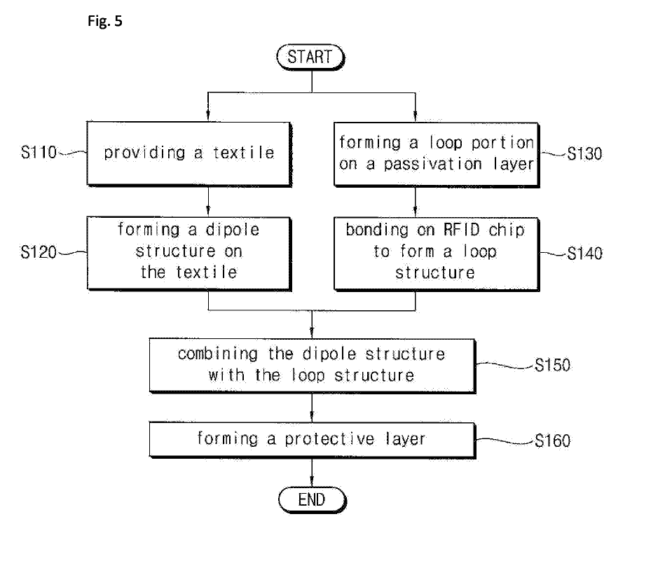

FIG. 5 is a flow chart illustrating a method of manufacturing an RFID tag in accordance with an example embodiment of the present invention.

Referring to FIG. 5, in step S110, provided is a textile having a loop region and a dipole region defined adjacent to the loop region.

Then, in step S120, a dipole structure is formed on the textile and in the dipole region. The dipole structure has a dipole portion to be configured to receive an electric wave from outside. The dipole structure may be formed using a conductive paste. In other words, the dipole portion may be formed by a direct printing process. For example, the direct printing process includes a screen printing process, a flexographic printing process, rotary printing process, gravure printing process, offset printing process, etc. Since the conductive paste may include a solvent, the heat treatment process may be further performed to remove the solvent.

The conductive paste may include conductive particles having at least one of silver (Ag), copper (Cu), silver-coated copper (Ag-coated Cu) and silver-coated iron (Ag-coated Fe), a binder and a solvent.

In case that the conductive paste includes copper having a tendency to be easily oxidized to form an oxidation layer on an outer face of the particles, A process for removing the oxidation layer may be further carried out. The process for the removing the oxidation layer may be performed using a diluted solution mixing water with a strong acid like sulfuric acid, nitric acid, hydrochloric acid, etc.

In step 130, a loop portion is formed on a passivation layer. The loop portion is formed in the loop region. The loop portion may be capacitive coupled to the dipole portion. The passivation layer may include polyimide film. Alternatively, the passivation layer may paper sheet.

The loop portion may be formed using a conductive paste. The loop portion may be formed by a direct printing process. For example, the direct printing process includes a screen printing process, a flexographic printing process, rotary printing process, gravure printing process, offset printing process, etc. Since the conductive paste may include a solvent, the heat treatment process may be further performed to remove the solvent. The loop portion may be formed using a conductive material substantially identical to that of the dipole portion.

In step S140, a RFID chip is bonded on the passivation layer. The RFID chip having a driving circuit may be connected to the loop portion. The RFID chip may communicate an electric wave with the loop portion. Thus, a loop structure including the dipole portion and the RFID chip is formed on the passivation layer.

In step S150, the dipole structure and the loop structure are combined to each other with exposing the passivating layer. An adhering portion like glue may be used to combine the dipole structure with the loop structure.

In a step 160, a protective layer is formed on the textile to cover the dipole portion such that the protective layer may protect the dipole portion. The protective layer may be formed using a ultra-violet cured material. That is, the protective layer may be formed using resin having a photo-initiator. Thus, when resin is exposed to ultra-violet ray, photo-polymerization reaction may occur by the photo-initiator to form the protective layer on the textile.

In an example embodiment, after forming a UV cured layer on the textile to cover the dipole portion, UV rays are irradiated toward the UV cured layer to cure the UV cured layer. Thus, the protective layer may be formed on the textile to cover the dipole portion.

In an example embodiment, an auxiliary protective layer (not shown) is further formed on an entire upper face of the textile to cover the dipole region and the loop region. The auxiliary protective layer may be formed using a material substantially identical to that of the protective layer. The auxiliary protective layer may inhibit the loop portion, the dipole region or the RFID chip from damage which may occur when separating the RFID chip from the textile in case of failure of the RFID chip.

In an example embodiment, prior to forming the dipole structure on the textile, a planarizing layer may be formed on an upper face of the textile. The planarizing layer may help the antenna or the RFID chip to be safely disposed on the textile.

The planarizing layer may be formed using a polyurethane material. The polyurethane material may include isocyanate and polyol. The planarizing layer may be formed having a thickness of about 0.01 mm to about 20.00 mm.

In one example embodiment, the planarizing layer may be formed through a laminating process. In other words, a polyurethane film having the polyurethane material is positioned on the textile and the polyurethane film is thermally pressed toward the textile to form the planarizing layer on the textile. According to the laminating process, the textile and the polyurethane film are mounted on a roll and the textile and the polyurethane film are heated. Then, the polyurethane film is pressed toward the textile to form the planarizing layer on the textile.

In another example embodiment, the planarizing layer may be formed through a coating process. According to the coating process, a polyurethane material is casted or sprayed on a textile to form the planarizing layer on the textile. For example, a polyurethane material having a liquid phase is coated on the textile using a mixing head, on the other hand, the polyurethane material is coated on the textile using a spraying head.

Reliability Evaluation after Washing

Both an RFID tag having a protective layer (Example) and an RFID tag without the protect layer (Comparative) were adapted as a care label for the parallel, respectively. The hand holder loader was used for test reliability of the RFID tags. The Example has a recognition distance of about 1.5 m (before washing) and about 1.1 m to about 1.2 m (after washing). In the meantime, the Comparative has a recognition distance of about 1.5 (before washing) and has not a measurable recognition distance after washing.

Although the example embodiments of the present invention have been described, it is understood that the present invention should not be limited to these example embodiments but various changes and modifications can be made by those skilled in the art within the spirit and scope of the present invention as hereinafter claimed.

What is claimed is:

1. An RFID tag comprising:
a textile including a loop region and a dipole region defined adjacent to the loop region;
a dipole portion disposed in the dipole region and on the textile to be configured to receive an electric wave from outside;
a loop portion disposed in the loop region and over the dipole portion to be configured to be capacitive coupled to the dipole portion to form an antenna together;
an RFID chip interposed between the dipole portion and the loop portion, the RFID including a driving circuit for receiving and transmitting an electric wave through the antenna; and
a protective layer disposed on the textile with covering the dipole portion to protect the dipole portion.

2. The RFID tag of claim 1, wherein the protective layer includes a UV-cured material.

3. The RFID tag of claim 1, further comprising a passivation layer covering the loop portion to be configured to passivate the loop portion and the RFID chip.

4. The RFID tag of claim 1, further comprising an adhesion portion to adhere the RFID chip to the textile.

5. The RFID tag of claim 1, wherein each of the dipole portion and the loop portion includes at least one of conductive metal particles selected from the group consisting of silver (Ag), copper (Cu), silver-coated copper (Ag-coated Cu) and silver-coated iron (Ag-coated Fe).

6. The RFID tag of claim 1, further comprising a planarizing layer disposed on an upper face of the textile, to have a flat upper face of the planarizing layer.

7. The RFID tag of claim 6, wherein the planarizing layer includes polyurethane.

8. A method of manufacturing an RFID tag, comprising:
providing a textile including a loop region and a dipole region defined adjacent to the loop region;
forming a dipole structure having a dipole portion in the dipole region and on the textile to be configure to receive an electric wave from outside
forming a loop portion on a passivation layer to correspond to the loop region, the loop porting being capacitive coupled to the dipole portion;
bonding an RFID chip having a driving circuit for communicating an electric wave with the loop portion to form a loop structure on the passivation layer;
combining the dipole structure with the loop structure with exposing the passivation layer; and
forming a protecting layer on the textile, the protecting layer covering the dipole portion to protect the dipole portion.

9. The method of claim 8, wherein forming the protective layer comprises:
forming a UV-cured layer covering the dipole region on the textile; and
exposing the UV-cured layer to UV rays to cure the UV-cured layer.

10. The method of claim 8, wherein combining the dipole structure with the loop structure is performed using an adhesion portion.

11. The method of claim 8, further comprising:
forming a planarizing layer having a plane upper face on the textile.

12. The method of claim 11, wherein forming the planarizing layer includes a laminating process using polyurethane material.

13. The method of claim 11, wherein forming the planarizing layer includes a coating process using polyurethane material.
